(19) United States
(12) Patent Application Publication
(10) Pub. No.: US 2004/0178605 A1
(43) Pub. Date: Sep. 16, 2004

(54) Bicycle identity plate with integrated sound producing element

(76) Inventor: Zachary W. Lyon, Lenior, NC (US)

Correspondence Address: STEVEN L. NICHOLS, RADER, FISHMAN & GRAVER PLLC, 10653 S. RIVER FRONT PARKWAY, SUITE 150, SOUTH JORDAN, UT, 84095, US

(21) Appl. No.: 10/798,619

(22) Filed: Mar. 10, 2004

Related U.S. Application Data
(60) Provisional application No. 60/453,511, filed on Mar. 12, 2003.

(51) Int. Cl. B62H 1/00

(52) U.S. Cl. 280/288.4

(57) ABSTRACT

An accessory for a vehicle having a wheel with spokes includes a vibratory member configured to be vibrated by the spokes of a rotating wheel; and a main body supporting the vibratory member on the vehicle, where the main body includes an identity plate.

### RELATED APPLICATION

The present application claims priority under 35 U.S.C. § 119(e) from a previously filed U.S. provisional patent application, Application No. 60/453,511, filed Mar. 12, 2003, entitled “Bicycle Identity Plate with Integrated Sound Producing Element.”

### BACKGROUND

To increase the fun of riding a bicycle, children have discovered the trick of extending a flexible card into the spokes of the bicycle wheel. As the wheel rotates while the bike is being ridden, the spokes will repeatedly deflect and snap the flexible card producing a humming noise that is somewhat similar to that of an engine. In this way, the bike rider can pretend that the bicycle is motorized or can otherwise enjoy the noise made by riding the bicycle.

Utilizing, for example, a playing card, a baseball card or a piece of corrugated cardboard that is attached to the frame of the bicycle with, for example, a clothes pin, children have found that the emulated sound of an engine adds value to their riding experience. Children using their imaginations can the pretend that they are actually driving in or riding on the vehicle of a favorite racer.

### SUMMARY

An accessory for a vehicle having a wheel with spokes includes a vibratory member configured to be vibrated by the spokes of a rotating wheel; and a main body supporting the vibratory member on the vehicle, where the main body includes an identity plate.

### BRIEF DESCRIPTION OF THE DRAWINGS

The accompanying drawings illustrate various embodiments of the present invention and are a part of the specification. The illustrated embodiments are merely examples of the present invention and do not limit the scope of the invention.

FIG. 1 is an exploded view of a bicycle accessory as disclosed herein including an identity plate and a sound-generating member.

FIG. 2 is another exploded view of the accessory of FIG. 1 as seen from a front side.

FIG. 3 is a view of a main body of the accessory of FIG. 1 with several cross-sectional views, including a cross-sectional view of the vibratory member.

FIG. 4. a perspective view of the front side of the accessory of FIG. 1

FIG. 5 a perspective view of the rear side of the accessory of FIG. 1

FIG. 6 is a more detailed view of the vibratory member of the accessory of FIG. 1.

FIG. 7 is an alternative embodiment of the vibratory member described herein.

FIGS. 8 and 9 include various views of the flat panels of the accessory of FIG. 1 on which identification or decorative elements may be disposed.

FIG. 10 includes various views of the accessory described herein in an assembled state with the vibratory member connected to the main body of the accessory.

FIG. 11 illustrates a sheet of stickers as an example of elements of a packaged kit including the accessory described herein.

FIG. 12 illustrates the installation of the accessory described herein on a bicycle.

Throughout the drawings, identical reference numbers designate similar, but not necessarily identical, elements.

### DETAILED DESCRIPTION

As will be described herein, a novel accessory for a bicycle can provide an integrated noise-making feature with an identity plate. The present specification will also describe a novel method of attached a noise-making accessory to a bicycle.

As used herein and in the appended claims, an identity plate is a distinguishing feature that distinguishes the bicycle to which it is attached. For example, the identity plate may have some reference to motor sports. The identity plate may include a racer's number, a representation of a wheel, a racecar or the like. The identity plate may also be in the form of a cartoon character or some other character or object well known to children. The identity plate, therefore, has a decorative or identification function beyond merely supporting a noise-making device.

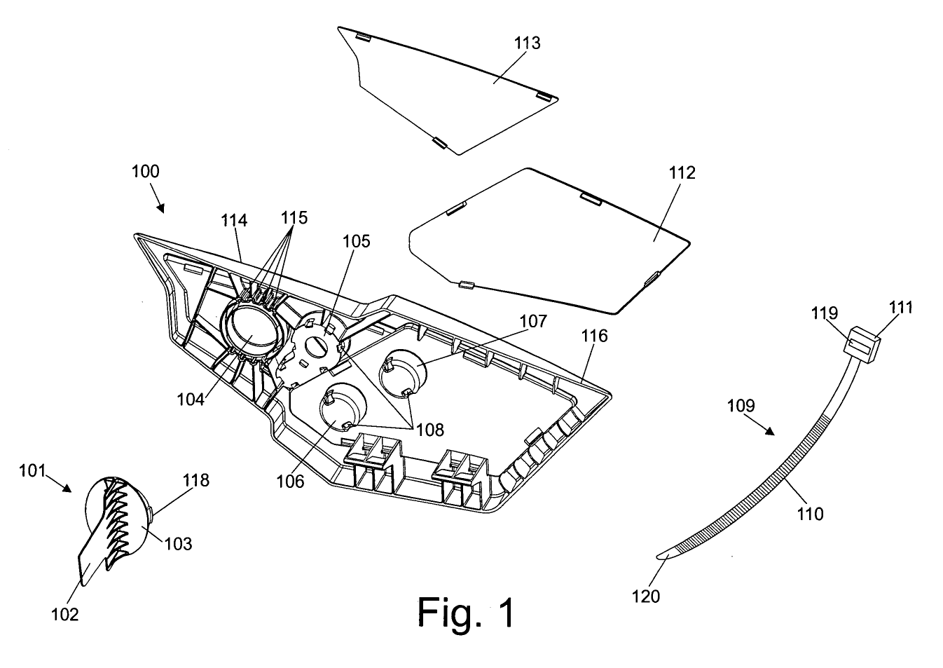

FIG. 1 illustrates an exploded view of an accessory for a bicycle having a noise-making feature integrated with an identity plate. As shown in FIG. 1 the accessory (100) has a main body (116) that may be made, for example, from molded plastic. The accessory (100) includes a vibratory member (101) that, when the accessory (100) is installed on a bicycle, vibrates in the spokes of the bicycle's wheel to produce the desired sound like that of an internal combustion engine. The vibratory member (100) includes a flexible extension (102) that extends between the spokes of the bicycle's wheel and a base (103) with which the member (101 ) is attached to the main body (116) of the accessory (100).

In the illustrated embodiment, the base (103) of the vibratory member (101) snaps into a socket (104) on the main body (116) of the accessory (100). Flexible tabs (118) may be provided on the base (103) of the vibratory member (101) to engage the socket (104) when the vibratory member (101) is snapped into the socket (104).

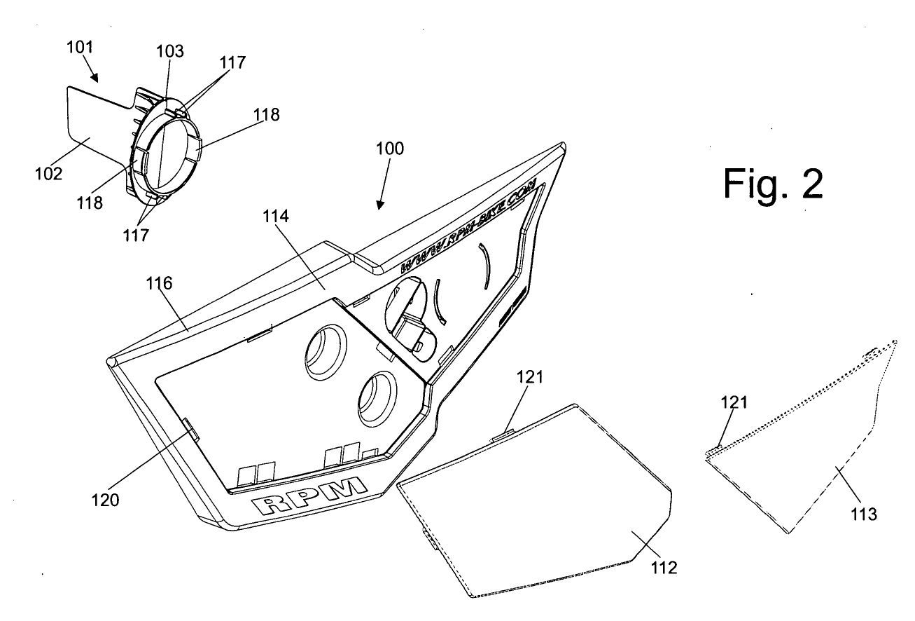

As shown in FIG. 1, the socket (104) may have a number of notches (115) formed around the periphery of the socket (104) opening. Corresponding tabs (117, FIG. 2) on the base (103) of the vibratory member (101) are mated into these notches (115) when the vibratory member (101) is snapped into the socket (104).

With the plurality of notches (115) around the periphery of the socket (104), the vibratory member (101) can be snapped into the socket (104) with the flexible extension (102) disposed at a variety of angles with respect to the main body (116). In the embodiment of FIG. 1, the flexible extension (102) can be disposed at one of three different angles with respect to the main body (116) depending on which notches (115) receive the tabs (117, FIG. 2) when the vibratory member (101) is snapped into the socket (104). This allows the flexible extension (102) to be extended at a variety of angles so that the optimal angle can be chosen based on different geometries that are presented by bicycles ranging in size, for example, from 16 inch to 26 inch wheel size. Ideally, the flexible extension (102) will be parallel, or roughly parallel with the spokes of the bicycle wheel as those spokes strike the extension (102).

To attach the accessory (100) to a bicycle, ridged plastic ties (109), known as “zip ties” can be used. As shown in FIG. 1, a zip tie (109) is an elongated plastic strip with ridges (110) along the length of the tie. A head (111) includes a slot (119) through which the end (120) of the tie can be inserted to form a closed loop. As more of the length of the tie (109) is pulled through the slot (119), the loop becomes smaller. The slot (119) is configured to only allow the ridges (110) on the tie (109) to pass in one direction. Thus, as the loop formed by the tie (109) decreases in size, the loop size cannot increase, thereby forming a tight hold on anything over which the loop is tightened.

As will be described, these zip ties (109) can be used to secure the accessory (100) to a bicycle. In the illustrated embodiment, three cylindrical protrusions are formed on the main body (116) of the accessory (100). These protrusions (105, 106 and 107) extend from a rear surface of the main body (116).

Each protrusion (105-107) has at least two communicating holes (108) that extend through the protrusion. To install the accessory (100), a zip tie (109) is threaded through the holes (108) of each protrusion (105-107). The zip tie (109) is then wrapped around a part of the frame of the bicycle and the loop of each tie (109) is closed and the tie is pulled tight to secure the accessory to the bicycle frame.

At least one of the protrusions (105) may have a number of holes disposed around a periphery of the protrusion (105). This allows a zip tie (109) to be inserted through the protrusion (105) at a number of different angles with respect to the main body (116). This allows the accessory (100) to be most optimally attached to a variety of differently sized bicycles.

A front surface (114) of the main body (116) of the accessory (100) may include one or more flat panels which constitute an identity plate on which some decorative or identification feature may be disposed. In the embodiment of FIG. 1, there are two separate flat panels (112,113) that can be snapped to the front surface of the main body (116) of the accessory (100). On these panels (112, 113) may be disposed, for example, numbers like the race identification numbers of a vehicle in a race. Additionally, a name, picture or other decorative or identifying feature may be disposed on the panel or panels of the front surface of the accessory (100).

With the integration of the identity plate and the noise-making features of the accessory (100), a child can personalize his or her bicycle, pretend to be a famous racer or other individual and thereby enhance the enjoyment of riding the bicycle.

FIG. 2 illustrates an exploded view of the accessory (100) from the opposite side as shown in FIG. 1. As seen in FIG. 2, the front side (114) of the accessory receives the panels (112,113) as described above. Tabs (120) on the main body (116) and tabs (121) on the panels (112, 113) allow the panels (112, 113) to be snapped to the main body (116) of the accessory (100).

In this way, set of multiple panels (112, 113) can be provided with the accessory (100). Different number or other personalizations may be made on different sets of panels (112,113) that can then be selectively attached to the accessory (100).

FIG. 2 also provides a view of the tabs (117) on the vibratory member (101) that are received in the notches (115, FIG. 1) of the socket (104, FIG. 1) on the main body (116). FIG. 2 also provides a better view of the flexible tabs (118) which snap the vibratory member (101) in the socket (104, FIG. 1). The flexible tabs (118) are preferably received between inner and outer rings of the socket (104, FIG. 1). The notches (115, FIG. 1) are formed in the outer ring of the socket (104, FIG. 1).

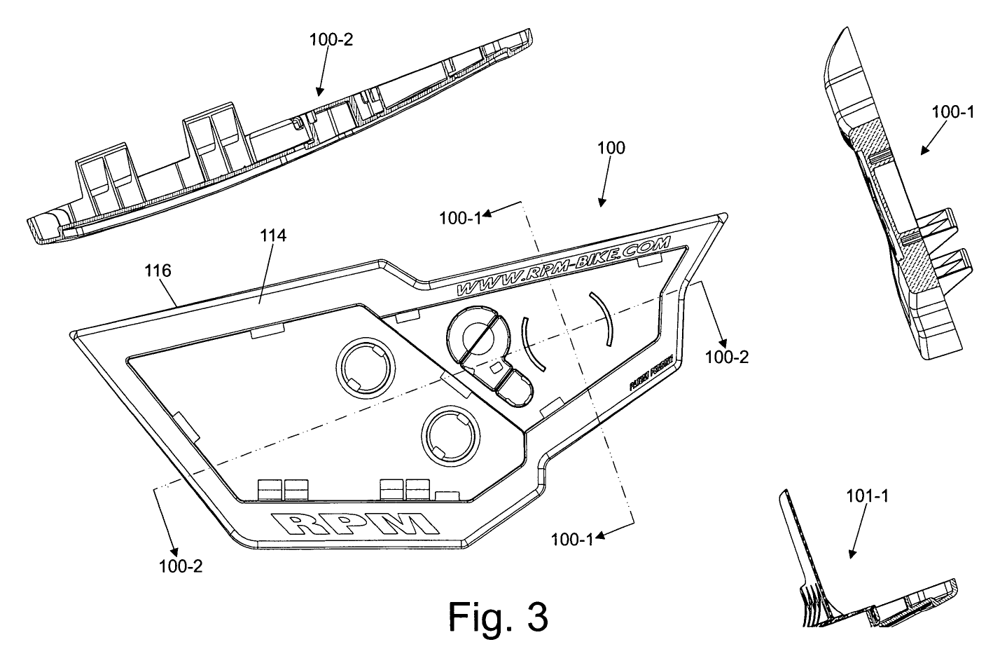

FIG. 3 provides another view of the accessory (100). FIG. 3 includes a straight-on view of the main body (116). FIG. 3 also includes a cross-sectional view (100-1) of the main body (116) taken through the socket (104, FIG. 1). FIG. 3 also includes a cross-sectional view (100-2) taken along the length of the main body (116), also through the socket (104, FIG. 1). Finally, FIG. 3 includes a cross-sectional view of the vibratory member (101-1).

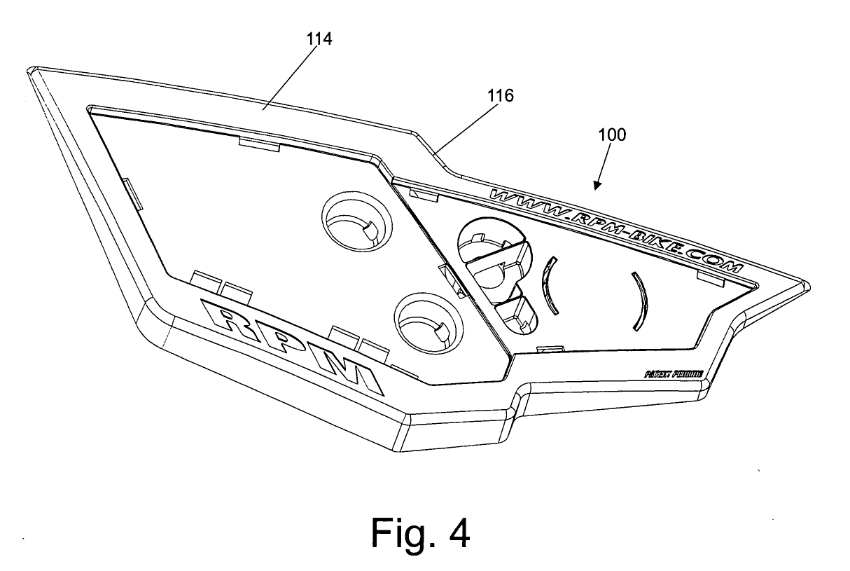

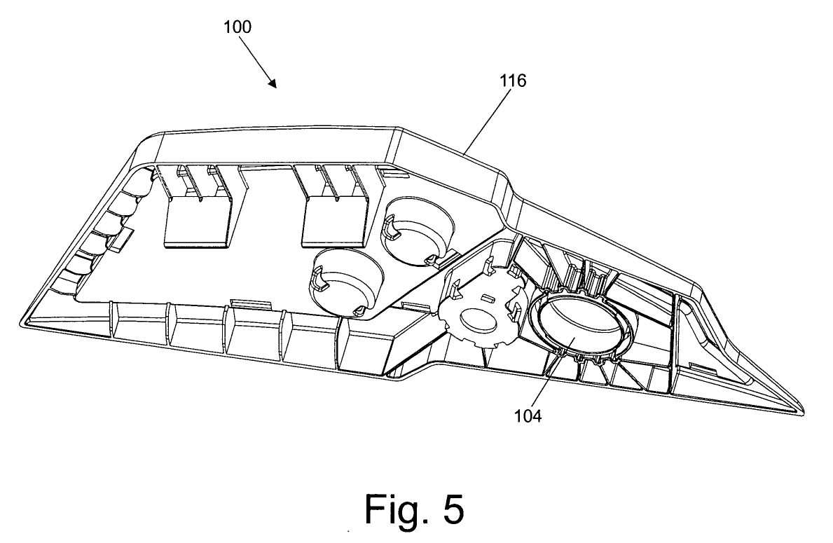

FIG. 4 provides another view of the front side (114) of the main body (116) of the accessory (100). FIG. 5 provides another view of the back side of the main body (116) of the accessory (100).

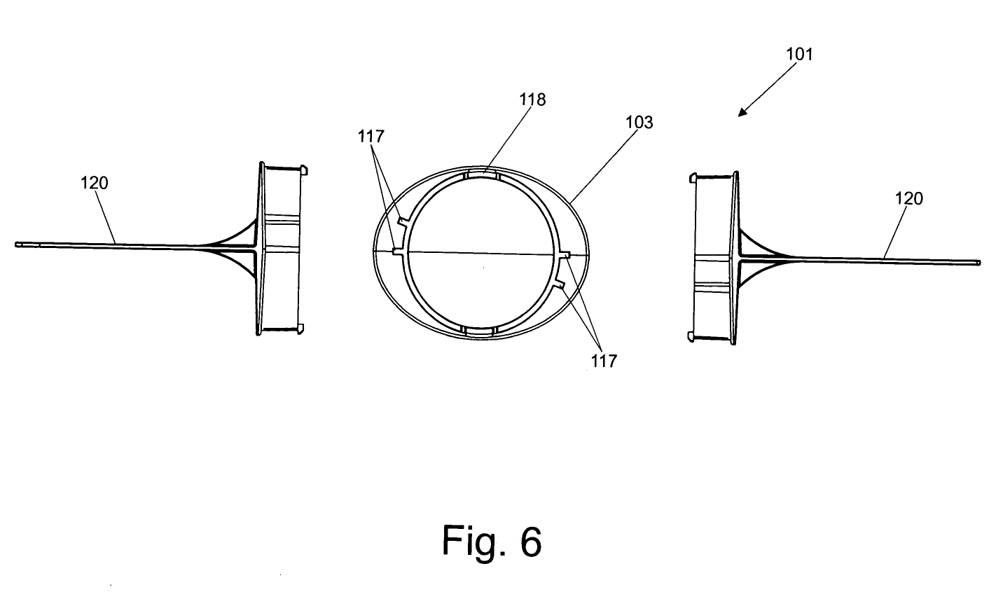

FIG. 6 is a more detailed illustration of the vibratory member (101) as described above. As shown in FIG. 6, the vibratory member (101) includes a base (103) and the flexible extension (102). On the base (103) are disposed the tabs (117) that are received in the notches (115, FIG. 1) of the socket (104, FIG. 1) on the main body (116). Also on the base (103) are the flexible tabs (118) which snap the vibratory member (101) in the socket (104, FIG. 1). As noted above, the flexible tabs (118) are preferably received between inner and outer rings of the socket (104, FIG. 1). The notches (115, FIG. 1) are formed in the outer ring of the socket (104, FIG. 1).

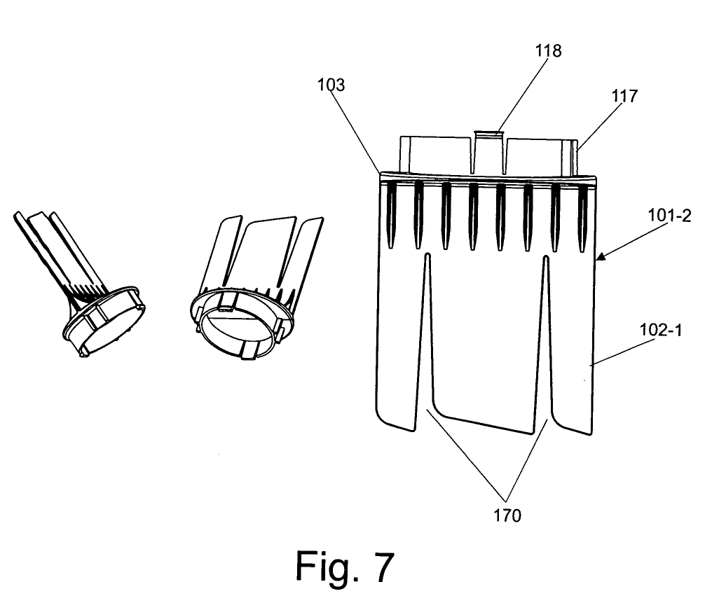

FIG. 7 illustrates an alternative embodiment of the vibratory member (101-2). As shown in FIG. 7, the alternative vibratory member (101-2) has a flexible extension (102-1) that is split. The flexible extension (102-1) may have one or more splits (170) that divide the extension (102-1). The edges of the split portions of the extension (102-1) may be tapered and rounded as shown in FIG. 7. Having a split flexible extension (102-1) can provide different sounds when the accessory is installed on a bike and may extend the useful life of the accessory.

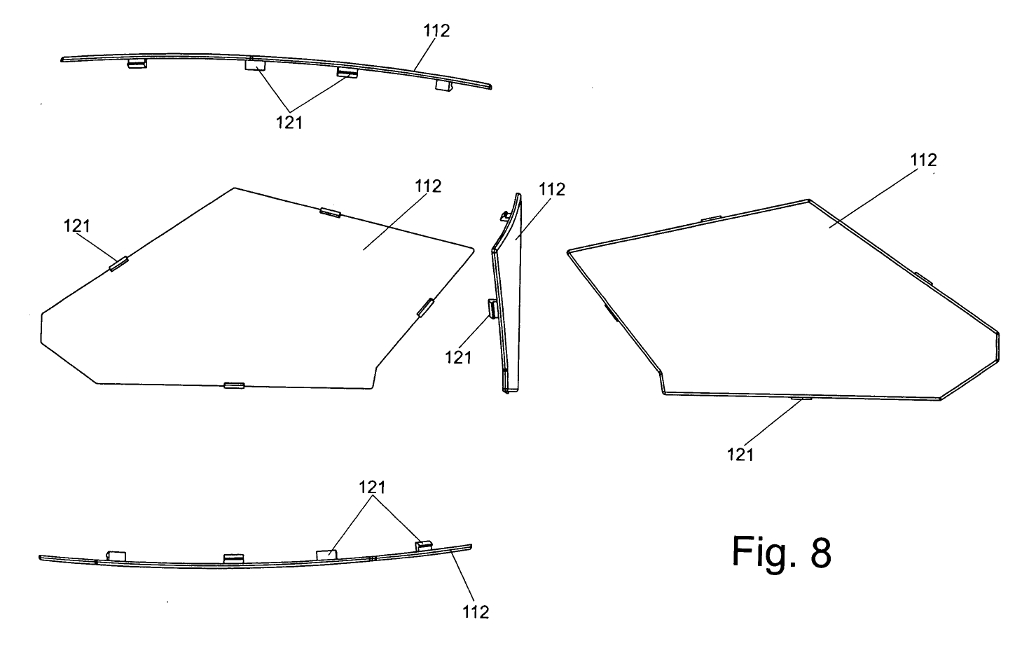

FIG. 8 shows various front, rear, side, top and bottom views of the flat panel (112) which is attached to the main body (116) of the accessory (100). As described above, numbers, letters, pictures and other identification indicia or decorative features can be disposed on the panel (112).

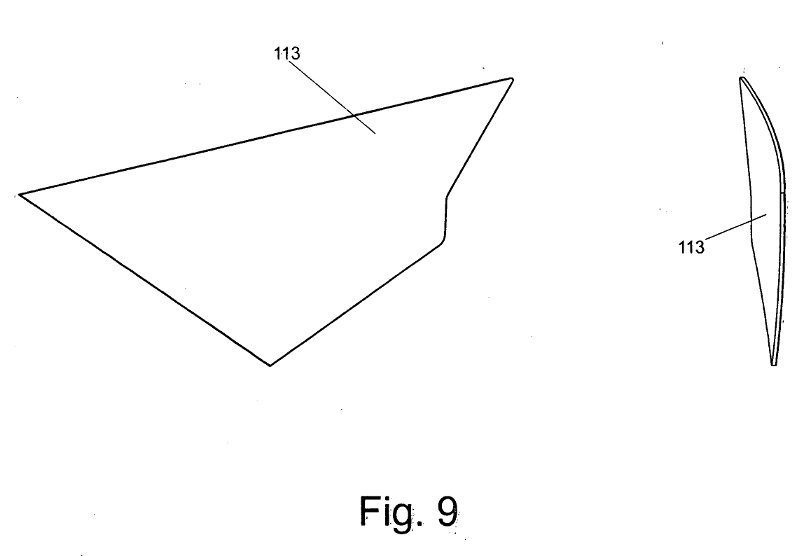

FIG. 9 shows various views of the other flat panel (113) which is attached to the main body (116) of the accessory (100). As described above, numbers, letters, pictures and other identification indicia or decorative features can be disposed on the panel (113).

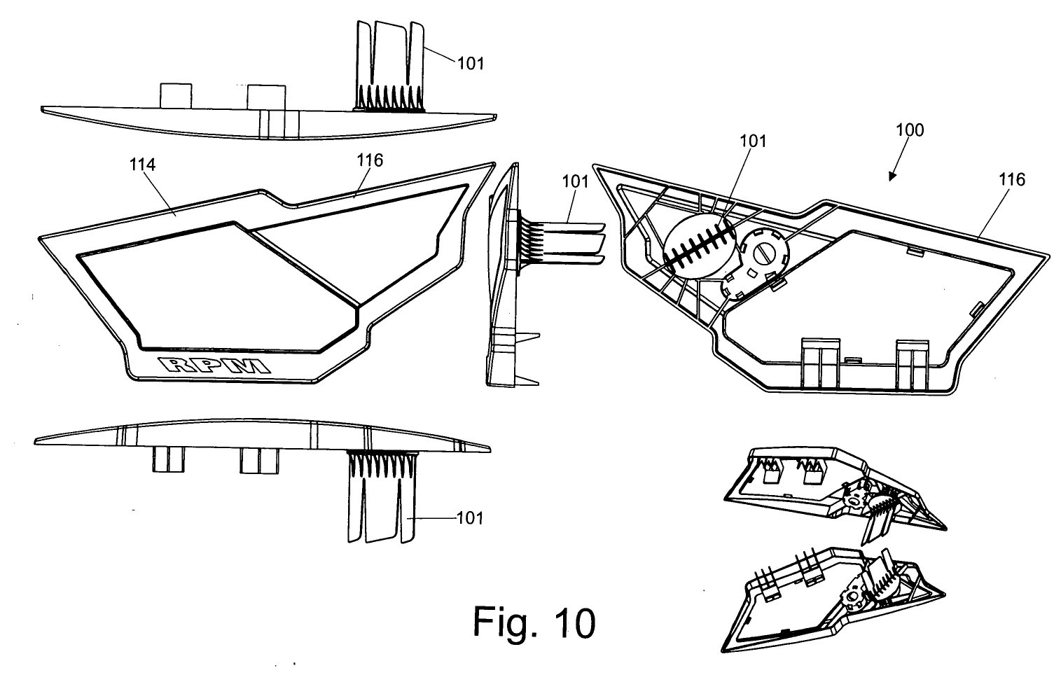

FIG. 10 shows various views of the accessory (100) described herein as assembled with the vibratory member (101) attached to the main body (116) of the accessory (100). FIG. 10 includes front, rear, top, bottom, side and perspective views of the assembled accessory (100).

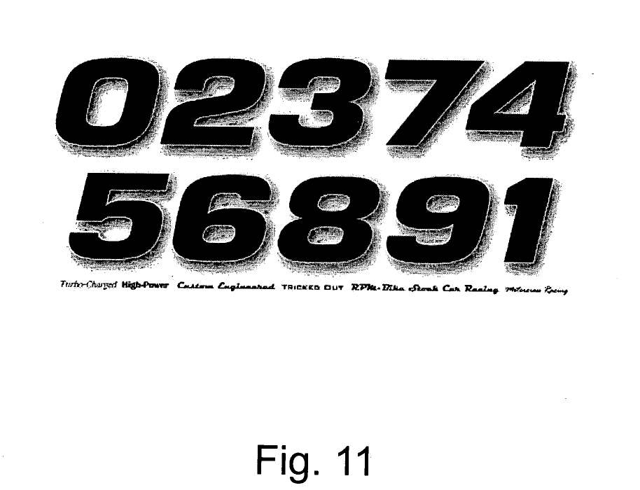

FIG. 11 illustrates a sheet of stickers bearing numbers 0-9. A sheet of numbers stickers or stickers with letters, names, pictures, or other identification or decorative elements may be packaged and sold with the accessory (100) described above. For example, stickers, such as those shown in FIG. 11, and the accessory (100), in any of the embodiments described herein, be wrapped or packaged together for commercial sale to a consumer.

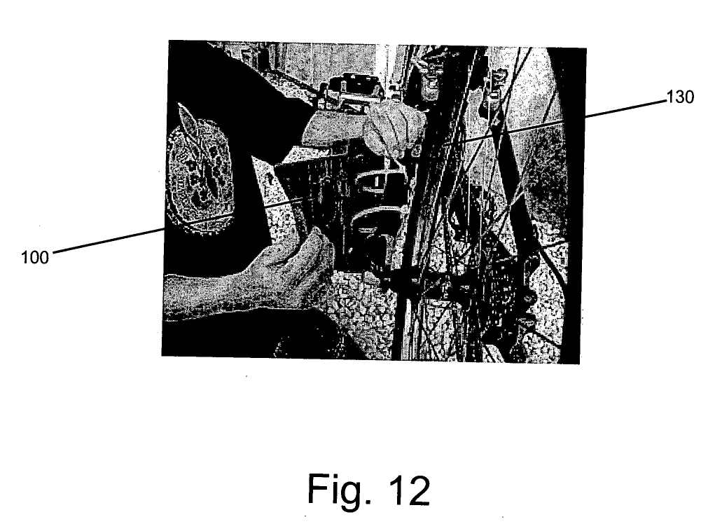

FIG. 12 is an illustration of the accessory (100) described herein being installed on a bicycle (130).

The preceding description has been presented only to illustrate and describe embodiments of the invention. It is not intended to be exhaustive or to limit the invention to any precise form disclosed. Many modifications and variations are possible in light of the above teaching. It is intended that the scope of the invention be defined by the following claims.

What is claimed is:

1. An accessory for a vehicle having a wheel with spokes, said accessory comprising:
a vibratory member configured to be vibrated by the spokes of a rotating wheel; and
a main body supporting said vibratory member on said vehicle, said main body further comprising an identity plate.

2. The accessory of claim 1, wherein said identify plate bears identification numbers.

3. The accessory of claim 2, wherein said numbers are stickers.

4. The accessory of claim 1, wherein said vibratory member snaps into a socket on said main body.

5. The accessory of claim 4, wherein flexible tabs on said vibratory member are configured to snap fit between inner and outer rings of said socket.

6. The accessory of claim 4, wherein said vibratory member is configured to snap into said socket at a variety of angles with respect to said main body so as to accommodate differently sized bicycles.

7. The accessory of claim 6, further comprising notches disposed around a periphery of said socket for receiving tabs disposed around a periphery of said vibratory member, said notches corresponding to said variety of angles.

8. The accessory of claim 1, wherein said accessory comprises three points at which said accessory is attached to a bicycle.

9. The accessory of claim 8, wherein each of said points comprises a zip tie threaded through said main body.

10. The accessory of claim 8, wherein at least one of said points comprises a plurality of holes disposed around a periphery of a protrusion such that a said zip tie can be threaded through said holes a plurality of angles with respect to said main body.

11. The accessory of claim 1, further comprising a zip tie threaded through said main body for attaching said accessory to said vehicle.

12. The accessory of claim 1, wherein said identity plate comprises one or more removable panels attached to said main body.

13. The accessory of claim 1, wherein said vibratory member comprises a base and a flexible extension, wherein said flexible extension is split into two or more portions.

14. The accessory of claim 13, wherein said splits are tapered, narrowing toward said base.

15. The accessory of claim 13, wherein a corner of one ore more of said portions is rounded.

16. A packaged kit comprising:
an accessory for a vehicle having a wheel with spokes, said accessory comprising;
a vibratory member configured to be vibrated by the spokes of a rotating wheel; and
a main body supporting said vibratory member on said vehicle, said main body further comprising an identity plate; and
a variety of identification indicia or decorative elements that can be selectively disposed on said identity plate.

17. The kit of claim 16, wherein said variety of identification indicia or decorative elements comprise a sheet of stickers.

18. The kit of claim 16, wherein said variety of identification indicia or decorative elements comprise numbers.

19. An accessory for a bicycle having a wheel with spokes, said accessory comprising:
means for generating sound in response to rotation of said wheel; and
a main body supporting said means for generating sound, said main body further comprising an identity plate;
wherein said accessory is configured to attachment to a frame of said bicycle.

20. The accessory of claim 19, further comprising a variety of identification indicia or decorative elements that can be selectively disposed on said identity plate.
